(19) United States
(12) Patent Application Publication
(10) Pub. No.: US 2020/0332878 A1
(43) Pub. Date: Oct. 22, 2020

(54) Steering Gear and Method for Producing the Steering Gear

(71) Applicant: Robert Bosch GmbH, Stuttgart (DE)

(72) Inventors: Jens-Uwe Hafermalz, Waeschenbeuren (DE); Dennis Fuechsel, Schwaebisch Gmuend (DE)

(21) Appl. No.: 16/755,602

(22) PCT Filed: Sep. 5, 2018
(86) PCT No.: PCT/EP2018/073796

§ 371 Date: Apr. 13, 2020

(30) Foreign Application Priority Data
Oct. 23, 2017 (DE) 10 2017 218 853.7

(51) Int. Cl. F16H 57/022; F16H 19/04; B62D 3/12; F16C 19/16

(52) U.S. Cl. CPC F16H 57/022; F16H 19/04; F16C 2326/24; F16C 19/16; B62D 3/12

(57) ABSTRACT

A steering gear for a steering system of a motor vehicle includes a housing, a gear, a pinion which meshes with the gear, and a pinion shaft that includes the pinion. The pinion shaft is mounted in a fixed bearing on a first side of the pinion, the fixed bearing having a rotary bearing in which the pinion shaft is received and which is received in a bearing sleeve of the fixed bearing, and pivoting ring with an outer ring and an inner ring that are pivotably connected via one or more torsion webs. The inner ring is received in the bearing sleeve, and the outer ring is fixedly arranged in the housing. The bearing sleeve is made of plastic. Thus, the bearing sleeve can be produced in a simple manner and the bearing sleeve exhibits a relatively low component weight as a result of the plastic design.

The invention relates to a steering gear for a steering system and to a corresponding steering system, in particular a power-steering system, for a motor vehicle. The invention also relates to a method for producing such a steering gear.

Power-steering systems, which when steering generate an assistive torque and thereby reduce the steering torque that has to be applied to the steering column by the driver, are fitted in most motor vehicles.

The known power-steering systems are based on a steering gear which translates the drive output of a hydraulic or electric steering motor and transmits it to the steering column, for example. Such steering gears may take the form of a helical rolling-contact gear and in particular a crossed helical gear pair or worm gear. These then comprise a gear wheel, which may be directly or indirectly connected to the steering column, and a meshing pinion driven via a shaft of the steering motor.

One problem that has emerged with such steering gears is the backlash which occurs due to component tolerances, different rates of thermal expansion of the gear elements and/to due to wear. In the case of so-called alternate steering, in particular, that is to say in immediately successive steering movements with alternating steering lock, such backlash in the gear produces unwanted noises, which result from the alternating application of opposing flanks of the pinion and gear wheel teeth.

A known way of largely eliminating such backlash is to afford the pinion shaft pivotable support about an axis running perpendicular to the longitudinal axis of the pinion shaft and at a distance from the toothing engagement of the pinion and the gear wheel, and to press it against the gear wheel by means of one or more spring elements. Here the facility of the pinion shaft to pivot is regularly incorporated into one of the two bearings via which the pinion shaft is supported at the end. This bearing support is also referred to as a “fixed bearing”. The bearing support in the area of the other end is then designed with a defined play (so-called “floating bearing”; cf. DE 10 2005 035 020 A1, for example), in order to allow the deflection associated with such a pivoting movement. The fixed bearing is regularly provided on the drive side whilst the floating bearing is provided at the free end of the pinion shaft. The spring element(s) for pressing the pinion against the gear wheel can here be incorporated both into the floating bearing and into the fixed bearing.

Such a steering gear, in which the spring force for the springing is generated by means of the fixed bearing, is known, for example, from DE 10 2008 040 673 A1. In this steering gear a ball bearing, which accommodates the pinion shaft in the area of the fixed bearing, is externally supported in a swivel sleeve. The swivel sleeve comprises a bearing sleeve, which receives the ball bearing largely free of play, and an outer ring, which is held largely free of play in a mount of a steering gear housing, the outer ring and the bearing sleeve being connected via multiple torsion webs, which are twisted as the outer ring turns relative to the bearing sleeve. After assembling the steering gear, the torsion webs are twisted in such a way that the elastic recovery effect thereby generated produces springing of the pinion shaft.

The object of the invention is to improve a steering gear, the principle of which is disclosed by DE 10 2008 040 673 A1.

This object is achieved by means of a steering gear as claimed in patent claim 1. A method for producing such a steering gear forms the subject of patent claim 11. Advantageous developments of the steering gear according to the invention and preferred embodiments of the method according to the invention form the subjects of the further patent claims and/or emerge from the following description of the invention.

According to the invention a steering gear for a steering system of a motor vehicle is provided, which comprises at least a housing, a gear wheel, a pinion, in particular a helical pinion, meshing with the gear wheel, and a (helical) pinion shaft comprising the pinion.

On one side of the pinion the pinion shaft is supported in a fixed bearing, which comprises a pivot bearing, in which the pinion shaft is received. For this purpose, the pivot bearing comprises at least an inner bearing ring and an outer bearing ring, and possibly in a preferred embodiment as a rolling-contact bearing and in particular a ball bearing, multiple rolling elements, in particular balls, arranged between the bearing rings. The pinion shaft is received inside the inner bearing ring of the pivot bearing. The pivot bearing and in particular an outer bearing ring of the pivot bearing of the fixed bearing is furthermore received in a bearing sleeve. The fixed bearing moreover comprises a swivel ring, which comprises an outer ring and an inner ring, which are pivotably connected together via one or more torsion webs, the inner ring being received in the bearing sleeve and the outer ring being supported in the housing of the steering gear and in particular fixedly arranged (i.e. immovable in at least one, preferably in all directions).

According to the invention such a steering gear is characterized in that the bearing sleeve is at least partially, preferably wholly, made of plastic (in particular one or more thermoplastic materials). This firstly makes the bearing sleeve, the entire fixed bearing and hence the steering gear easy to produce. This moreover gives the bearing sleeve, formed from plastic, the distinctive feature of a relatively low component weight.

On the other side of the pinion the pinion shaft of a steering system according to the invention may preferably be supported in a floating bearing, which comprises a pivot bearing in which the pinion shaft is received, ensuring a radial mobility for the pivot bearing (and hence also for the end of the pinion shaft received therein) inside the housing. The pivot bearing, and in particular an outer bearing ring thereof, may preferably be received in a bearing bush, which is received inside the housing in such a way that a radial mobility of the pivot bearing, and hence of the end of the pinion shaft received therein, inside the housing is ensured.

Such a floating bearing may be of a design according to DE 10 2005 035 020 A1, for example. In particular, the bearing bush of the floating bearing may comprise an inner bushing receiving the pivot bearing, and an outer bushing enclosing the inner bushing and fixedly arranged in the housing, the outer bushing and the inner bushing defining an annular gap and the outer bushing and the inner bushing being connected together via a flexible connecting portion, in such a way that these are moveable relative to one another in at least one radial direction.

The bearing bush may alternatively also be designed in such a way that this is connected to a stop element or is itself formed as a stop sleeve, either of which is arranged so that it is displaceable and at the same time rotationally secured inside a receiving space of the housing, the swiveling mobility of the pinion shaft, guided by the fixed bearing, being limited by bearing contact between the stop element or the stop sleeve and a preferably cylindrical wall of the receiving space, the stop element or the stop sleeve on the one hand and the receiving space on the other being formed in such a way that only in the event of such bearing contact, due to the interaction of then touching contact faces of the stop element or the stop sleeve and the wall of the receiving space, is a swiveling mobility of the pinion shaft additionally blocked about an axis oriented perpendicularly to the swivel axis.

The pivot bearing of the floating bearing of the steering gear according to the invention comprises at least an inner bearing ring and an outer bearing ring, and possibly in a preferred embodiment as a rolling-contact bearing and in particular a ball bearing, multiple rolling elements, in particular balls, arranged between the bearing rings, the pinion shaft being received inside the inner bearing ring and in so doing preferably coming into direct contact with the latter. The outer bearing ring may be received, preferably with direct contact, inside the bearing bush of the floating bearing.

Such a steering gear according to the invention may preferably be further characterized in that the bearing sleeve and/or an outer bearing ring of the pivot bearing of the fixed bearing is connected directly or indirectly (for example via a bearing bush of the floating bearing) to an outer bearing ring of the pivot bearing of the floating bearing by a connecting element, which may be formed in one or more parts. The connecting element here may in particular be formed in such a way that this transmits at least a load, which leads to tilting of the outer bearing ring of the pivot bearing of the fixed bearing, directly or indirectly to the outer bearing ring of the pivot bearing of the floating bearing. This ensures that the restoring torque of the elastically twisted torsion webs of the swivel ring of the fixed bearing is no longer transmitted to the pinion shaft exclusively via the pivot bearing of the fixed bearing, in order to press said shaft against the gear wheel, but that the swiveling load stress of the bearing sleeve of the fixed bearing, resulting from the restoring torque, is additionally or primarily transmitted to the pivot bearing of the floating bearing, and hence to the end of the pinion shaft supported therein, via the connecting element. A contact between the pinion and the gear wheel, produced between the fixed bearing and the floating bearing, gives rise to a loading of the pivot bearings, which is oriented substantially radially, due to the restoring torque of the twisted torsion webs. A transmission of a tilting moment at the relevant level from the pivot bearings, and in particular from the pivot bearing of the fixed bearing, to the pinion shaft can thereby be prevented. This advantageously allows the pivot bearing of the fixed bearing and/or the pivot bearing of the floating bearing to be of relatively small dimensions, which may have positive implications in terms of the size and the weight and the production costs of a steering gear according to the invention. Furthermore, a pivot bearing of relatively simple design, preferably a single-row radial ball bearing, may be selected for the fixed bearing and/or the floating bearing, which can likewise have positive implications in terms of the size and the weight and the production costs of a steering gear according to the invention.

The bearing bush which is intended to support the pivot bearing of the floating bearing may preferably also be formed by the connecting element itself.

According to a preferred embodiment of a steering gear according to the invention with connecting element, the connecting element may be of at least partially tubular formation. In particular, the connecting element may be of tubular formation over its entire length, enclosing the pinion shaft, a (preferably the single) opening provided in the tubular shell of the connecting element being arranged in the area of the pinion and extending over a part of the circumference and a part of the length of the tubular shell, and allowing an engagement of the pinion with the gear wheel. Such a tubular connecting element is relatively rigid, considering the weight of the component, which allows an advantageous transmission of a swiveling load from the bearing sleeve and/or the outer bearing ring of the pivot bearing of the fixed bearing to the floating bearing.

In one embodiment of a steering gear according to the invention that is advantageous particularly for production engineering reasons, the connecting element may be integrally formed with the bearing sleeve (i.e. at least directly connected together) and preferably formed in one piece (i.e. not connected together by separate connecting elements), in particular also from the same material. The unit comprising the bearing sleeve and the connecting element may more preferably be formed as a one-piece component from one or more plastics, in particular from a single plastic.

In such an embodiment of a steering gear according to the invention in particular, the pivot bearing of the floating bearing can then be directly or indirectly supported inside an (end) portion of the connecting element and a (the same or another) portion of the connecting element inside the (then separate) bearing bush of the floating bearing. This can, in particular, make such a steering gear according to the invention relatively easy to assemble.

According to a preferred embodiment of a steering gear according to the invention the bearing sleeve, and possibly the connecting element, formed in one piece therewith, can be formed as an injection-molded part, thereby advantageously facilitating production.

The invention also relates to a method for producing a steering gear according to the invention, in which the bearing sleeve and/or the connecting element, in particular the one-piece unit comprising the bearing sleeve and the connecting element, is/are formed from plastic by injection molding. Here the gate may preferably be arranged annularly in the area of at least one of the axial ends of the injection-molded component to be produced.

In producing a bearing sleeve and/or the connecting element as injection-molded component(s), an asymmetrical configuration may have negative effects, since these may lead to a correspondingly asymmetrical distortion of the injection-molded component(s) due to setting and cooling of the plastic. In order to prevent this, the cross-sectional or radial section areas of the bearing sleeve and/or the connecting element may preferably, as far as possible, be of rotationally symmetrical formation, but at least as far as possible and preferably exactly point-symmetrical formation about the (respective or common) longitudinal axis. In the case of the bearing sleeve, rotationally symmetrical cross-sectional areas can easily be achieved substantially over the entire longitudinal extent. Only in that area in which the torsion webs are fed through the circumferential surface of the bearing sleeve may it be necessary to provide cross-sectional areas which are not rotationally symmetrical and possibly not even point-symmetrical. Since this is only a relatively small portion of the longitudinal extent of the bearing sleeve, however, this may present no problems in terms of distortion of the bearing sleeve. In the case of the connecting element, however, an opening through which an engagement of the tooth systems of the pinion and the gear wheel is allowed, may present problems in this respect. In order to obtain at least point symmetry in this possibly relatively long portion of the longitudinal extent of the connecting element, the connecting element in this portion of its longitudinal extent may comprise not only the opening allowing engagement of the toothing systems but in addition a preferably identically formed opening offset by 180° about the longitudinal axis. In this longitudinal portion the connecting element is then formed by two connecting braces, offset by 180° about the longitudinal axis and preferably arranged so that they are point-symmetrical, which may also each consist of a plurality of secondary braces. Here the connecting braces may preferably take the form of partially cylindrical shell bodies.

For an advantageous design, appropriate to the load, of the plastic bearing sleeve and/or the tubular connecting element, preferably connected in one piece to the bearing sleeve, reinforcing ribs running in a longitudinal direction may be formed on its/their outsides. Here the reinforcing ribs may preferably be arranged in a circumferential direction over the entire outside of the bearing sleeve and/or of the tubular connecting element and/or uniformly distributed in a circumferential direction.

According to a further preferred embodiment of a steering gear according to the invention, the bearing sleeve may form a circumferential step, on which an axial end of an outer bearing ring of the pivot bearing of the fixed bearing is directly or indirectly supported. This serves, in particular, in making a steering gear according to the invention relatively easy to produce and assemble.

According to a preferred development of such a steering gear according to the invention, the inside diameter of the step at the edge situated in proximity to the pivot bearing may then still be made larger than the inside diameter of the outer bearing ring at the edge situated in proximity to the step, and/or larger than the inside diameter at the edge of a preferably disk-shaped annular element, arranged between the outer bearing ring and the step, situated in proximity to the step. This serves, in particular, to prevent plastic getting into the pivot bearing during the production of a sub-assembly comprising at least the pivot bearing of the fixed bearing, the swivel ring and the bearing sleeve of the fixed bearing, when the bearing sleeve is formed by injection molding, at least the outer bearing ring of the pivot bearing and the inner ring of the swivel ring being partially embedded in the plastic.

The bearing sleeve more preferably forms two circumferential steps, on each of which an axial end of the outer bearing ring of the pivot bearing rests (directly or indirectly, in the latter case particularly via the inner ring of the swivel ring). Accordingly, a group of components comprising the outer bearing ring of the pivot bearing, the inner ring of the swivel ring and one or more annular elements may advantageously be arranged so that they are axially immovable between circumferential steps of the bearing sleeve. This can advantageously be achieved by producing the bearing sleeve by injection molding whilst at the same time embedding this group of components in the plastic. One particular advantage that may accrue from such a design of the fixed bearing of a steering gear according to the invention is that through shrinkage of the bearing sleeve as the plastic sets and cools, a prestressing can be generated acting on the group of components in an axial and/or radial direction, so that the components of this group of components touch one another and also the inside of the bearing sleeve without any play. An unwanted noise behavior of the steering gear in operation, otherwise caused by such play, can therefore be prevented without the need for special design measures.

The annular body of the annular element(s) may possibly have an L-shaped cross-sectional area or radial section area, in order to achieve a relatively high load-bearing capacity in an axial direction. The annular element or one of the annular elements may also be the inner ring of the swivel ring.

The invention also relates to a steering system which comprises at least one steering gear according to the invention and a steering motor connected and providing rotational drive to the pinion shaft. The gear wheel of the steering gear may furthermore be rotationally fixed or connected for the provision of rotational drive to a steering shaft, in particular a steering column, of the steering system. The steering system according to the invention may take the form, in particular, of a power-steering system, in which the steering motor serves to generate an assistive torque, so that a steering-wheel torque which a driver of a motor vehicle comprising the power-steering system has to apply to the steering column in order to steer the motor vehicle is reduced (possibly temporarily even to zero). Alternatively, it is also possible to design the steering system in such a way that the steering motor always generates all the steering wheel torque required for steering, particularly in order to endow the steering system and the motor vehicle with a so-called steer-by-wire functionality, in which no mechanical connection exists between a manual steering control (if any is still provided) and the steered wheels.

The invention further relates to a motor vehicle having a steering system according to the invention.

The indefinite articles (“a”, “an”, “of a”, “of an”), particularly in the patent claims and in the description generally explaining the patent claims, are to be interpreted as such and not in a numerical sense.

Correspondingly specified components are therefore to be interpreted as existing at least in the singular and possibly in the plural.

The invention is explained in more detail below, referring to an exemplary embodiment represented in the drawings, in which:

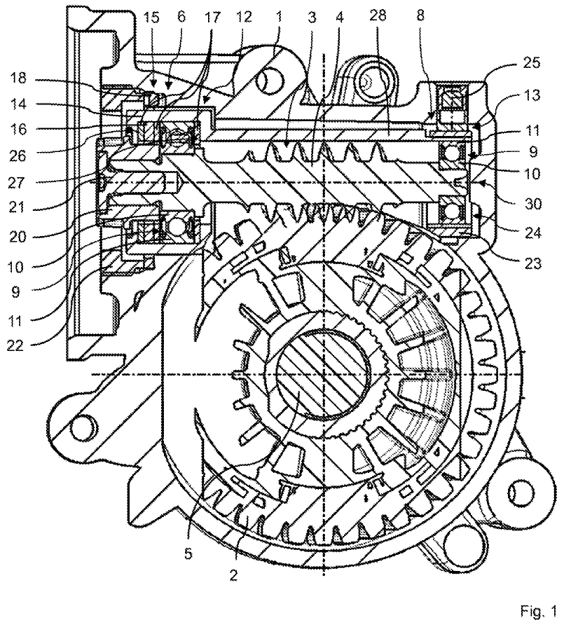

FIG. 1: shows a longitudinal section through a steering gear according to the invention in a first embodiment;

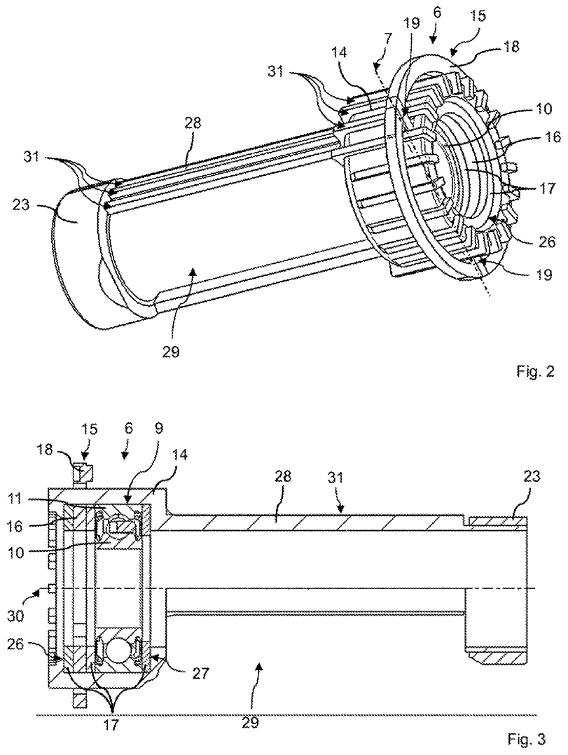

FIG. 2: shows the fixed bearing, the connecting element integrally formed therewith and the stop ring of the steering gear according to FIG. 1 in a perspective view;

FIG. 3: shows the fixed bearing with integrated connecting element and stop ring according to FIG. 2 in a longitudinal section;

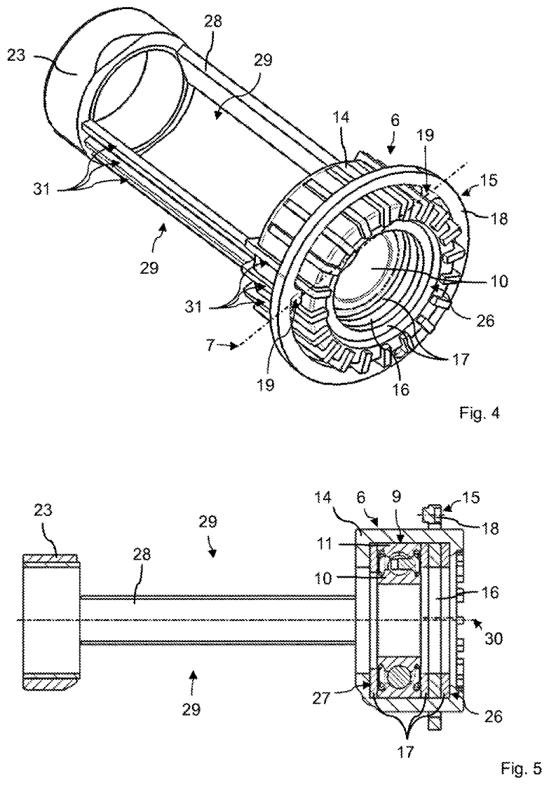

FIG. 4: in a perspective view shows a fixed bearing, a connecting element integrally formed therewith and a stop ring for a steering gear according to the invention in a second embodiment;

FIG. 5: shows the fixed bearing, the connecting element and the stop ring according to FIG. 4 in a longitudinal section;

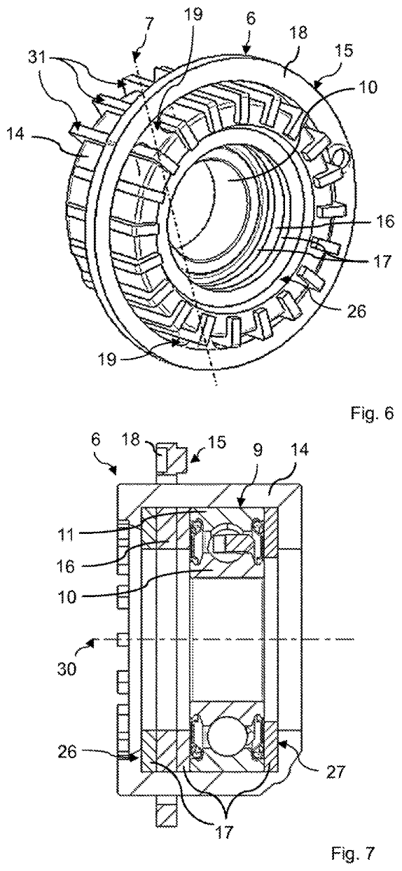

FIG. 6: in a perspective view shows a fixed bearing for a steering gear according to the invention in a third embodiment; and

FIG. 7: shows the fixed bearing according to FIG. 6 in a longitudinal section.

FIG. 1 shows the main constituent parts of a steering gear according to the invention. This comprises a housing 1, inside which a gear wheel 2 and a pinion 3 in the form of a helical pinion meshing with the gear wheel 2 are rotatably arranged. The pinion 3 and a (helical) pinion shaft 4 comprising the pinion 3 are integrally formed as a worm.

The gear wheel 2 is firmly fixed on an output shaft 5 of the steering gear. This output shaft 5, which in the exemplary embodiment shown comprises a toothing for a secure, rotationally fixed connection to the gear wheel 2, can mesh, for example, with a steering track rod formed at least in one portion as a rack, so that the rack performs a translational movement, which in a known manner can be translated via steering arms (not shown) into a swiveling movement of steered wheels (not shown) of the motor vehicle. The output shaft 5 may also be a steering column of a power-steering system, however, which is connected to a steering wheel and acts on the steering track rod via a steering pinion.

The pinion shaft 4 has a drive-side end, via which the shaft can be connected to the output shaft of a steering motor (not shown; for example an electric motor). In the area of this drive-side end the pinion shaft 4 is supported in the housing 1 by means of a first bearing. This bearing takes the form of a fixed bearing 6, which allows the pinion shaft 4 to swivel about a swivel axis 7 (cf. FIG. 2). This swivel axis 7 here in FIG. 1 runs approximately perpendicular to the drawing plane. Such swiveling causes a deflection of the opposite end of the pinion shaft 4 to the drive-side end, the shaft there being supported by means of a floating bearing 8 in a corresponding mount of the housing 1. This floating bearing 8 is designed so that it will permit the deflection of this end resulting from the swiveling of the pinion shaft 4.

Both the fixed bearing 6 and the floating bearing 8 each comprise a pivot bearing in the form of a ball bearing 9. The corresponding portions of the pinion shaft 4 are supported in inner bearing rings 10 of these ball bearings 9, whilst outer bearing rings 11 of the ball bearings 9 are each supported in a bearing device 12, 13, which are in turn received in the housing 1. The bearing devices 12, 13 are designed so that in the case of the fixed bearing 6 they allow the pinion shaft 4 to swivel about the swivel axis 7, and in the case of the floating bearing 8 they allow deflection of the free end of the pinion shaft 4.

For this purpose, the bearing device 12 of the fixed bearing 6 comprises a bearing sleeve 14 having an annular cross section, which inside, in a first longitudinal portion, receives the associated ball bearing 9, and in a second longitudinal portion an inner ring 16 of a swivel ring 15. This inner ring 16 of the swivel ring 15 and the outer bearing ring 11 of the ball bearing 9 are supported, axially secured, inside the bearing sleeve 14 with the insertion of multiple annular elements 17, the inner ring 16 being supported on the one hand on the outer bearing ring 11 of the ball bearing 9 and on the other on a first circumferential step 26, formed by the bearing sleeve 14 at one axial end, in each case with the insertion of an annular element 17. Similarly, the side of the outer bearing ring 11 of the ball bearing 9 situated remotely from the inner ring 16 of the swivel ring 15 is supported, with the insertion of an annular element 17, on a second circumferential step 27, formed by the bearing sleeve 14 at this axial end.

Besides the inner ring 16 the swivel ring 15 also comprises an outer ring 18. This outer ring 18 is connected to the inner ring 16 via two torsion webs 19 (cf. FIG. 2). The outer ring 18, the inner ring 16 and the torsion webs 19 are preferably formed in one piece from spring steel, for example.

The inner bearing ring 10 of the ball bearing 9 of the fixed bearing 6 is axially secured in position on the pinion shaft 4, with the insertion of a thrust piece 20, by means of a bolt 21, which is screwed into an internal thread which is incorporated into the drive-side end of the pinion shaft 4. The outer ring 18 of the swivel ring 15 is axially secured in position inside the housing 1 by means of a threaded ring 22, which has an external thread which is screwed into an internal thread of the housing 1.

The two torsion webs 19 define the position of the swivel axis 7, about which the outer ring 18 is able to swivel relative to the inner ring 16 of the swivel ring 15. The torsion webs 19 of the swivel ring 15 here not only allow a swiveling of the outer ring 18 relative to the inner ring 16, and hence of the pinion shaft 4 relative to the gear wheel 2 and to the housing 1, but at the same time produce that spring force which presses the pinion 3 into the toothing of the gear wheel 2, in order to achieve the least possible backlash and thereby the minimum possible noise developed in the operation of the steering gear, particularly in alternate steering. This spring force results from the fact that in assembling the steering gear the pinion shaft 4 is deflected so far through contact with the gear wheel 2 that a twisting of the torsion webs 19 occurs, sufficient for the elastic restoring torques resulting from this twisting of the torsion webs 19 to counteract the displacement of the pinion shaft 4 and therefore to impel the latter against the gear wheel 2.

The bearing device 13 of the floating bearing 8 comprises a stop element in the form of a stop sleeve 23, which is movably arranged inside a receiving space 24 formed by the housing 1, in such a way that the swiveling mobility about a swivel axis 7 defined by the fixed bearing 6 is possible within the limits of a basic design play. Here this basic play or this swiveling mobility is limited in one direction by a full contact or one occurring on two flanks of each of the individual teeth of the pinion 3 and the gear wheel 2, which is brought about by the spring loading by means of the twisted torsion webs 19, and in the other direction by a stop, which is formed by a contact of the annular stop sleeve 23 with a stop element 25 arranged in a receiving aperture of the housing 1. Here the depth to which the stop element 25 extends into the receiving space 24 may be adjustable at least once.

The steering gear further comprises a connecting element 28, which is materially integrated in one piece into the bearing sleeve 14 of the fixed bearing 6 or formed as an extension thereof. The connecting element 28, as emerges from FIGS. 1 and 3, is of tubular formation with annular or segmental-shaped cross sections and comprises a shell opening 29, which is arranged in a central portion of the connecting element 28 and which extends over a portion of its circumference. Through this shell opening 29 a portion of the gear wheel 2 can extend into the internal volume defined by the connecting element 28 and receiving the pinion shaft 4 in the portion forming, among other things, the pinion 3, in order to allow engagement of the tooth systems of the gear wheel 2 and the pinion 3.

A tubular end portion of the connecting element 28 extends into the floating bearing 8 of the steering gear, the ball bearing 9 of the floating bearing 8 with the associated outer bearing ring 11 being supported so that it is axially movable inside this end portion of the connecting element 28. This end portion of the floating bearing 28 is in turn internally supported in the stop sleeve 23 of the floating bearing 8. The connecting element 28 together with the stop sleeve 23 therefore forms a bearing bush for the ball bearing 9 of the floating bearing 8.

The connecting element 28 on the one hand means that the elastic restoring torques, which result from the torsion of the torsion webs 19 of the swivel ring 15 of the fixed bearing 6, are not transmitted to the pinion shaft 4 exclusively via the ball bearing 9 of the fixed bearing 6, which would be associated with a relatively high buckling load of this ball bearing 9. Rather, these elastic restoring torques are transmitted to the ball bearing 9 of the floating bearing 8 primarily via the bearing sleeve 14 of the fixed bearing 6 and the connecting element 28 integrally connected thereto.

The bearing sleeve 14 of the fixed bearing 6 and the connecting element 28 integrally formed with the bearing sleeve 14 are produced in the form of an injection-molded component from a plastic, in particular a thermoplastic material. In producing this unit comprising the bearing sleeve 14 and the connecting element 28 by injection molding, the ball bearing 9 of the fixed bearing 6, the swivel ring 15 and the total of three annular elements 17 are partially overmolded by the plastic used for this. For this purpose, the inner bearing ring 10 of the ball bearing 9, the inner ring 16 of the swivel ring 15 and the two annular elements 17 in contact with this inner ring 16 are pushed onto a stepped portion of a first core (not shown). A second core (not shown), which is intended, in particular, to form the internal volume of the tubular connecting element 28, in an end portion of reduced diameter carries the third annular element 17 and at the end abuts the end of the inner bearing ring 10 of the ball bearing 9 situated remotely from the swivel ring 15. After positioning of the cores and the components carried by them, that is to say the ball bearing 9, the swivel ring 15 and the annular elements 17, inside a cavity of an injection molding tool (not shown), the free-flowing plastic can be introduced into the injection molding tool with the additional use of a radially movable slide valve (not shown), which forms the shell opening 29 of the connecting element 28, and brought to final curing. The gating here may preferably be performed annularly in the area of one of the axial ends of the injection molded component to be produced or via a plurality of injection points distributed over a circumference of the injection molded component or the cavity of the injection mold. A central gate (for example, diaphragm gate or disk gate) is also possible. Due to the fact that the inside diameter of the steps 26, formed by the bearing sleeve 14 is greater than the inside diameter of the annular elements 17 adjoining each of these (in each case relative to the near edge), the free-flowing plastic is prevented from getting into the ball bearing 9 during the injection molding process.

The setting and cooling of the plastic causes a shrinkage of the bearing sleeve 14, which elastically acts radially and axially on the contiguous arrangement of the outer bearing ring 11 of the ball bearing 9, the inner ring 16 of the swivel ring 15 and the three annular elements 17, thereby achieving an absence of play which has an advantageous effect on the noise behavior of the steering gear in operation.

The sub-assembly comprising the ball bearing 9 of the fixed bearing 6, the swivel ring 15, the annular elements 17 and the unit comprising the bearing sleeve 14 and the connecting element 28 can be removed from the mold in an axial direction relative to the longitudinal axis 30 once the slide valve, which is intended to form the shell opening 29, has been retracted.

The stop sleeve 23 of the floating bearing 8 is likewise composed of a thermoplastic material, which is relatively more elastic, however, compared to the plastic from which the unit, comprising the bearing sleeve 14 and the connecting element 28, is formed. This is intended to dampen noise generated due to contact with the stop element 25 during operation of the steering gear. The stop sleeve 23 may be produced separately, for example likewise by means of injection molding, and subsequently mounted on the corresponding end portion of the connecting element 28 and connected to the latter. Alternatively, however, it is also possible to produce the stop sleeve 23 and the unit comprising the bearing sleeve 14 and the connecting element 28 in the form of an integral injection molded component by a 2-component injection molding process.

As can be seen from FIG. 2 in particular, multiple reinforcing ribs 31, which are distributed at uniform intervals in a circumferential direction over the respective outer surface and which extend in a longitudinal direction of the bearing sleeve 14 or the connecting element 28 and run substantially parallel to the longitudinal axis 30, are formed on the outside of the bearing sleeve 14 and on the outside of the connecting element 28. The reinforcing ribs 31 of the bearing sleeve 14 here extend into the end face of the bearing sleeve 14 situated remotely from the connecting element 28, and into the end face which is situated in proximity to the connecting element 28 and which represents the external circumferential step that is formed in the transition between the bearing sleeve 14 and the connecting element 28. In these end faces the reinforcing ribs 31 run radially. The reinforcing ribs 31 of the bearing sleeve 14 and of the connecting element 28, which in each case merge in pairs into one another, are in particular intended to ensure a relatively high flexural stiffness for a simultaneously relatively low component weight of the unit comprising the bearing sleeve 14 and the connecting element 28.

FIGS. 4 and 5 represent a unit comprising a fixed bearing 6, a connecting element 28 and a stop sleeve 23 for a steering gear according to the invention in a second embodiment. With the exception of the connecting element 28 this steering gear may correspond to the steering gear according to FIG. 1. The connecting element 28 according to FIGS. 4 and 5 differs from that of the steering gear according to FIGS. 1 to 3 in that in that longitudinal portion in which this forms a (shell) opening 29, which allows a toothing engagement of the pinion 3 and the gear wheel 2, is formed with point-symmetrical cross-sectional areas. This is achieved in that the connecting element 28 in this longitudinal portion comprises an identically shaped shell opening 29 situated opposite said shell opening 29. In this longitudinal portion the shell of the connecting element is consequently reduced to two connecting braces, which have identical dimensions and are arranged offset by 180° about the longitudinal axis 30 or situated opposite one another. These connecting braces also have external reinforcing ribs 31.

FIGS. 6 and 7 show the fixed bearing 6 for a steering gear according to the invention in a third embodiment. This basically corresponds to the fixed bearing 6 of the steering gear according to FIGS. 1 to 3. There is no provision, however, for forming the bearing sleeve 14 of this fixed bearing 6 in one piece with a connecting element 28 and from the same material. A steering gear not further represented and comprising this fixed bearing 6, and which may otherwise correspond to that according to FIG. 1, for example, may be formed without such a connecting element 28. Alternatively, a separately formed connecting element 28 may subsequently be connected to the bearing sleeve 14 of the fixed bearing 6, in turn formed as a plastic injection molded component, according to FIGS. 6 and 7.

### LIST OF REFERENCE NUMERALS

1. housing
2. gear wheel
3. (helical) pinion
4. (helical) pinion shaft
5. output shaft of the steering gear
6. fixed bearing
7. swivel axis
8. floating bearing
9. ball bearing
10. inner bearing ring of a ball bearing
11. outer bearing ring of a ball bearing
12. bearing device of the fixed bearing
13. bearing device of the floating bearing
14. bearing sleeve
15. swivel ring
16. inner ring of the swivel ring
17. annular element
18. outer ring of the swivel ring
19. torsion web
20. thrust piece
21. bolt
22. threaded ring
23. stop sleeve
24. receiving space
25. stop element
26. first step of the bearing sleeve
27. second step of the bearing sleeve
28. connecting element
29. shell opening
30. longitudinal axis of the connecting element, the bearing sleeve, the ball bearings, the annular elements and the pinion shaft
31. reinforcing rib

1-12. (canceled)

13. A steering gear for a steering system of a motor vehicle, comprising:
a housing;
a gear wheel;
a pinion shaft comprising a pinion meshing with the gear wheel; and
a fixed bearing supporting the pinion shaft on a first side of the pinion the pinion shaft, the fixed bearing comprising:
a first pivot bearing, in which the pinion shaft is received and which is received in a bearing sleeve that is made of plastic and forms a circumferential step; and
a swivel ring, which comprises an outer ring and an inner ring, which are pivotably connected together via one or more torsion webs, the inner ring received in the bearing sleeve and the outer ring supported in the housing,
wherein a first inside diameter of the circumferential step at a first edge situated in proximity to the first pivot bearing is formed larger than a second inside diameter at a second edge of an annular element, which is arranged between a first outer bearing ring of the first pivot bearing and the circumferential step, the second edge situated in proximity to the circumferential step.

14. The steering gear as claimed in claim 13, wherein:
the pinion shaft is supported on a second side of the pinion in a floating bearing, which comprises a second pivot bearing in which the pinion shaft is received and provides a radial mobility for the second pivot bearing inside the housing, and
at least one of the bearing sleeve and the first outer bearing ring is connected via a connecting element to the second outer bearing ring.

15. The steering gear as claimed in claim 14, wherein the connecting element defines an opening in at least one longitudinal portion, the gear wheel extending into the opening.

16. The steering gear as claimed in claim 14, wherein the connecting element is formed in one piece with and from the same material as the bearing sleeve.

17. The steering gear as claimed in claim 14, wherein the second pivot bearing is supported inside a portion of the connecting element.

18. The steering gear as claimed in claim 13, wherein the bearing sleeve is formed as an injection-molded component.

19. The steering gear as claimed in claim 13, wherein reinforcing ribs are formed on an outside of the bearing sleeve running in a longitudinal direction.

20. The steering gear as claimed in claim 13, wherein the circumferential step supports a first axial end of the first outer bearing ring.

21. The steering gear as claimed in claim 20, wherein the first inside diameter of the circumferential step, at the first edge, is formed larger than a third inside diameter of the first outer bearing ring at a third edge situated in proximity to the circumferential step.

22. The steering gear as claimed in claim 20, wherein the bearing sleeve further comprises a second circumferential step, which supports a second axial end of the first outer bearing ring.

23. The steering gear as claimed in claim 16, wherein the bearing sleeve and the connecting element are formed as an injection-molded component.

24. The steering gear as claimed in claim 14, wherein reinforcing ribs are formed on an outside of at least one of the bearing sleeve and the connecting element, the reinforcing ribs running in a longitudinal direction.

25. A method for producing a steering gear that includes (i) a housing, (ii) a gear wheel, (iii) a pinion shaft having a pinion meshing with the gear wheel, and (iv) a fixed bearing supporting the pinion shaft on a first side of the pinion the pinion shaft, the fixed bearing including a first pivot bearing, in which the pinion shaft is received and which is received in a bearing sleeve that is made of plastic and forms a circumferential step, and a swivel ring, which comprises an outer ring and an inner ring, which are pivotably connected together via one or more torsion webs, the inner ring received in the bearing sleeve and the outer ring supported in the housing, wherein a first inside diameter of the circumferential step at a first edge situated in proximity to the first pivot bearing is formed larger than a second inside diameter at a second edge of an annular element, which is arranged between a first outer bearing ring of the first pivot bearing and the circumferential step, the second edge situated in proximity to the circumferential step, the method comprising:
forming at least one of the bearing sleeve and the connecting element of injection molded plastic.

26. The method as claimed in claim 25, wherein the forming of the at least one of the bearing sleeve and the connecting element further comprises using an annular gate to form the injection molded plastic.
